(19) United States
(12) Patent Application Publication
(10) Pub. No.: US 2002/0005834 A1
(43) Pub. Date: Jan. 17, 2002

(54) Computer mouse having data recording and decodeing function

(76) Inventor: Seung-Hwan Oh, Seoul (KR)

Correspondence Address: HARNESS, DICKEY & PIERCE, PLC, P.O. BOX 828, BLOOMFIELD HILLS, MI, 48303, US

(21) Appl. No.: 09/827,967

(22) Filed: Apr. 6, 2001

(30) Foreign Application Priority Data
Jul. 4, 2000 (KR) P 2000-18171

(51) Int. Cl. G09G 5/08; H04N 5/76

(52) U.S. Cl. 345/163; 348/231; 348/552

(57) ABSTRACT

A computer mouse having data recording and decoding function is comprises a card inserting part for inserting a memory card in a body of the computer mouse, an output part for reading and outputting data stored in the memory card, and a Moving picture experts group decoding part to control storing and decoding data by cooperating with the card inserting part having a memory card and the output part. Thereby, a moving picture experts group decoder or MP3 player can be affixed within the same body of a computer mouse or can be easily mounted on the top of the computer mouse. Therefore, a connecting means like a cable does not need to store data in a memory card. And the data can be played without any other MPEG decoder.

### BACKGROUND OF THE INVENTION

1. Field of the Invention

The present invention relates to a computer mouse, more particularly to a computer mouse for recording and decoding data receiving from a computer.

2. Prior Art

Generally, Moving Picture Experts Group (MPEG) is a name of International Associate related to dynamic image file and a format of the dynamic image file. The MPEG is a standard of the dynamic image file format and a compressed audio signal. An MP3 format derives from audio signal compressing technology of MPEG Layer-1. The MP3 means MPEG Layer-3 and belongs to the audio technology in the MPEG field. In order to download data such as an MP3 file, an MPEG file, etc. from the Internet to a conventional MP3 memory card, an MP3 player having the memory card should be connected with a USB(Universal Serial Bus) port of a computer.

Therefore, a user needs a cable having at least one connecting terminal for downloading data to the memory card and also should connect the connecting terminal to the computer.

However, it is not easy to connect the cable between the computer mouse and the computer because the USB port is located on the back of the computer.

### SUMMARY OF THE INVENTION

It is an object of the present invention to provide to store a necessary data in a memory card and to playback the data by using the computer mouse without any additional device.

It is another object of the present invention to provide to easily separate a computer mouse which can store and playback the data from the computer for using a portable MPEG decoder.

It is another object of the present invention to provide to easily affix and separate a MPEG decoder from a computer mouse for using a portable MPEG decoder.

In order to achieve the above objects, a computer mouse having data recording and decoding function, the computer mouse is comprised of a card inserting part for inserting a memory card in a body of the computer mouse; a output part for reading and outputting data stored in the memory card; and a Moving Picture Experts Group decoding part for controlling to store and decode data by cooperating with the card inserting part having a memory card and the output part. Preferably, the computer mouse is further comprising a cable connector for affixing or separating a cable connecting between the computer mouse and a computer; an operating part for generating a control signal to output the data.

A computer mouse according to another aspect of the present invention includes a Moving Picture Experts Group decoding part including a card inserting part for inserting a memory card, and an output part for outputting data stored in the memory card, and connecting terminals affixed each the Moving Picture Experts Group decoding part and the computer mouse for electrically and optionally connecting between the Moving Picture Experts Group decoding part and the computer mouse within a space for setting the Moving Picture Experts Group decoding part on body of the computer mouse.

A computer mouse according to another aspect of the present invention includes a mouse part including switching buttons for selecting one of command buttons displayed on a screen of a computer connected to the computer mouse, and a mouse controller for receiving a click signal by one of the switching buttons and for transmitting the click signal to the computer; and a Moving Picture Experts Group decoding part including a micro-computer for receiving data transmitted from the computer in response to the click signal, a memory card for storing the data according to control of the micro-computer, and an audio signal output part for outputting an audio signal in response of the control of the micro-computer.

Preferably, the MPEG part of the computer mouse is further comprised an audio signal decoder for receiving the audio signal from the memory card and decoding the audio signal; and a digital to analog converter for converting the digital audio signal decoded into an analog signal.

More preferably, the MPEG part of the computer mouse is further an audio video parser for receiving an audio video signal from the memory card and separating each an audio and a video signal; an audio signal decoder for decoding the audio signal outputted from the audio video parser; an audio signal output part for outputting the audio signal; a video signal decoder for decoding the video signal outputted from the audio video parser; and a video signal output part for outputting the video signal.

The Moving Picture Experts Group decoder further comprises a display part for displaying predetermined data.

The output part includes an earphone jack and a display part which are mounted at a surface of the computer mouse.

The computer mouse is connected with a Universal Serial Bus port mounted at the back of the computer. The Moving Picture Experts Group decoding part decodes and outputs an audio signal.

### BRIEF DESCRIPTION OF THE DRAWINGS

This invention will be better understood and its various objects and advantages will be more fully appreciated from the following description taken in conjunction with the accompanying drawings, in which:

FIG. 1 shows a computer mouse being mounted with an MPEG decoding part wherein according to the first embodiment of this invention;

FIG. 2 is a block diagram for illustrating an inner part of a computer mouse which is capable of outputting an audio signal;

FIG. 3 is a block diagram for illustrating an inner part of a computer mouse which is capable of outputting an audio and a video signal;

FIG. 4 shows a computer mouse having a structure which can affix or separate an MPEG decoding part according to the second embodiment of this invention; and

FIG. 5 shows a detailed circuit of the block diagram of FIG. 2.

### DETAILED DESCRIPTION OF THE PREFERRED EMBODIMENTS

### First Embodiment

Preferred embodiments of the present invention will be illustrated below with reference to the accompanying drawings.

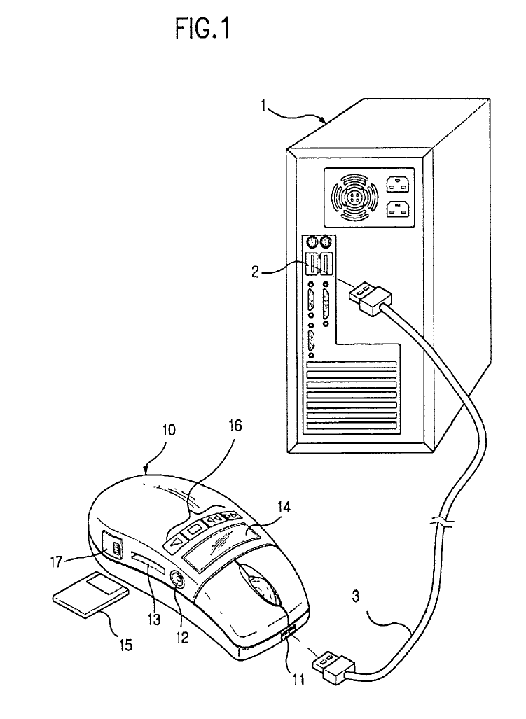

FIG. 1 shows a computer mouse is mounted with an MPEG decoding part according to the first embodiment of this invention.

Referring to FIG. 1, a computer mouse 10 according to the first embodiment of this invention is comprised of a cable connector 11, an earphone jack 12, a card inserting part 13, a display part 14, an operating part 16, and a portable power supply 17.

The computer mouse 10 is connected to a USB port 2 of a computer 1. A cable 3 which connects the computer mouse 10 and the USB port 2 has two terminals, i.e. a male terminal and a female terminal. The cable 3 can affix or separate the cable connector 11 and the USB port 2 of the computer 1. In order to connect the computer mouse and the computer machine, infrared layer may be used instead of the cable as shown in FIG. 1. Additionally, any other means for connecting the computer mouse and the computercan be applied according to the present invention.

The card inserting part 13 formed on the surface of the computer mouse 10 can receive a memory card 15 and affix the memory card 15. The card inserting part 13 can be formed on any surface of the computer mouse 10. Preferably, the card inserting part 13 is formed at a side of the computer mouse 10. Kinds of the memory card 15 include flash memory, smart media card, multi media card, and compact flash, etc. The memory card 15 can be inserted to any other MP3 player and playback data as well as the computer mouse of the present invention. Furthermore, the memory card 15 can store a document written by using a text editor, a word processor, etc. as well as mp3 file. Accordingly as the storage capacity increases, a dynamic image can be stored in the memory card 15.

The earphone jack 12 is formed at the computer mouse and outputs an audio signal outputted from the memory card 15 through the computer mouse 10.

When the memory card 15 which stores data file like an mp3 file is inserted into the computer mouse 10, one of the stored files is selected by a menu button of the operating button 16 which is formed on the top of the computer mouse 10. Then when a play button is pushed, the file is played back.

The display part 14 displays predetermined information. The display part 14 can use an LCD(Liquid Crystal Display), or LEDD(Light Emitting Diode Display), etc. The information includes information stored in the memory card 15, for example, memory information, a title of an mp3 file, playbacking time, as well as general information, such as time, data, power information, etc. Furthermore, if the display part 14 is made as predetermined size, a dynamic image stored in the memory card may be played.

The operating part 16 is comprised of buttons for searching files stored in the memory card 15 and for operating the MPEG decoding part, for example, on/off, play, stop, fast wind, pause, volume, etc.

The portable power supply 17 is formed to insert a battery into the computer mouse 10. When the computer mouse 10 is connected with the computer 1 which is turned on, a charged battery is automatically charged. Additionally, the portable power supply 17 allows the MPEG decoder to operate independently after separating from the computer 1.

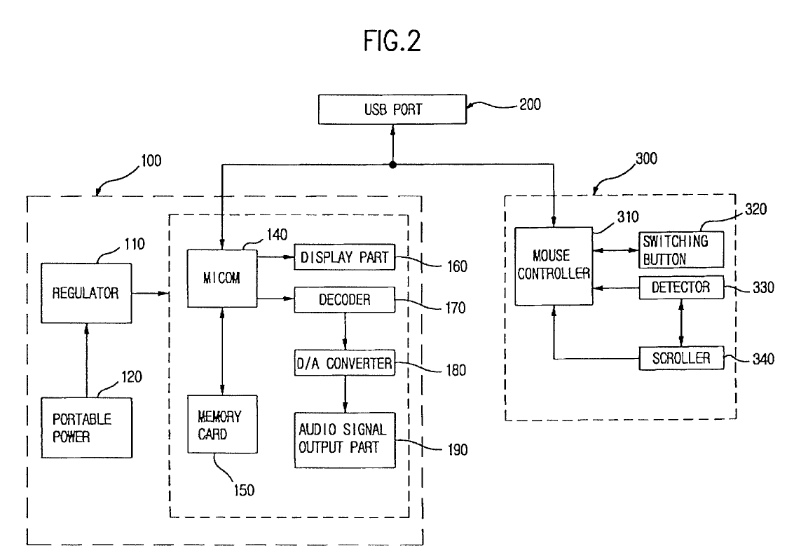

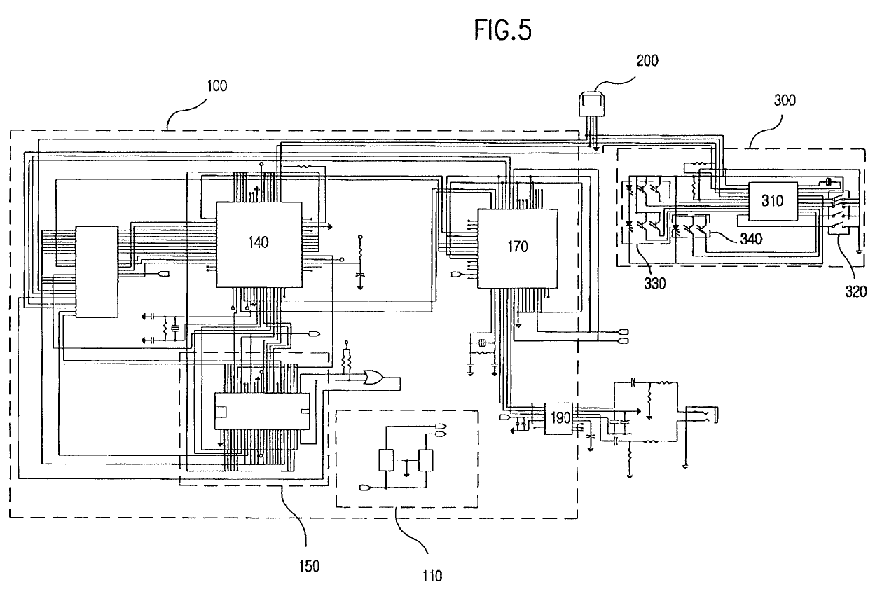

FIG. 2 is a block diagram for illustrating inner circuit part of a computer mouse which is capable of outputting an audio signal. The detailed circuit is shown in FIG. 5.

Referring to the FIG. 2, the inner circuit part of the computer mouse broadly classifies an MP3 player part 100, a USB port 200, and a mouse part 300.

The mouse part 300 is comprised of a mouse controller 310, a switching button 320, a detector 330, and a scroller 340.

The scroller 340 up, down, left, and right moves a screen of computer connected to the computer mouse.

The detector 330 is a means for moving a position on a screen of the computer mouse connected with the computer. Generally, a mouse ball rotation detector is used. However, an optical sensor for transmitting and receiving signal with computer by wireless and an acceleration sensor for acknowledging 3 dimensions can be substituted.

The switching button 320 selects a program that a user wants to have on a screen of the computer connected with the computer mouse, or clicks a file that a user wants to download on an Internet, or selects one of the command buttons used for transferring commands in order to operate a program of a user using a window program.

The mouse controller 310 is connected to the computer by the USB port 200, so as to transmit a click signal generated at the switching button 320 into the computer in response to the command signal transmitted from the computer. Additionally, the mouse controller 310 controls the switching button 320, the detector 330, and the scroller 340.

The MP3 player part 100 is comprised of a regulator 110, portable power supply 120, a micro computer 140, a memory card 150, a display part 160, decoder 170, a digital to analog converter 180, and an audio signal output part 190.

The regulator 110 converts voltage being input from an external unit like the portable power supply through the USB port 200 into predetermined voltage for uniformly maintaining, for example, 3.3V or 2.5V so as to output into other circuit elements.

The portable power supply 120 supplies power for operating the MP3 player within the computer mouse when a user separates the computer mouse from the computer and carries the computer mouse along with the computer mouse. The portable power supply 120 can consist of a common battery or a charged battery as conventional method. Additionally, the portable power supply 120 may be affixed as a charged battery within the computer mouse.

The micro-computer 140 stores programs for controlling each of the elements and performing process. The programs can execute files such as a MP3 file, a dynamic image file, etc. and also control storage of a document written by using a text editor, a word processor in a memory card, etc.

The memory card 150 can store selected data, i.e. necessary data on a screen of the computer connected to the computer mouse by using a switching button 320 of the computer mouse. Thus, the memory card 150 can store a document written by using a text editor, a word processor, etc.

The display part 160 displays information of files stored in the memory card 150 and time information, etc. by cooperating with the micro-computer 140. The display part 160 also displays a video signal generating from a dynamic image file when the dynamic image file is stored in the memory card 150.

The decoder 170 decodes a signal inputted from the micro-computer 140 and outputs the signal.

The digital to analog converter 180 converts a digital audio signal outputted from the decoder 170, so as to output the signal into an audio signal output part 190 like an earphone jack.

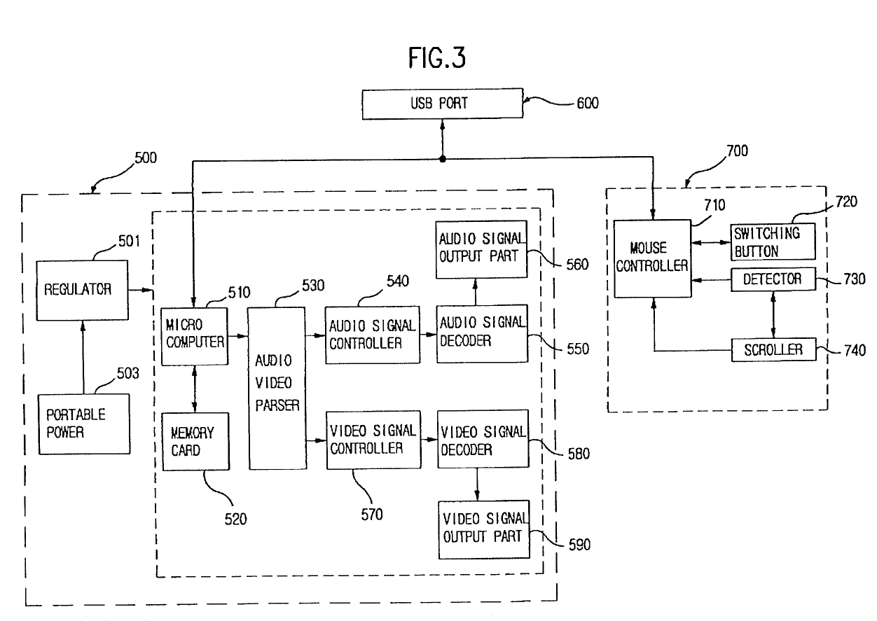

FIG. 3 is a block diagram for illustrating an inner part circuit of a computer mouse which is capable of outputting audio and video signals. The inner part circuit as shown in FIG. 3 is also applied to the first embodiment.

Referring to FIG. 3, the inner part circuit of the computer mouse is comprised of a Moving Picture Experts Group(hereinafter simply referred to as “MPEG”) decoding part 500, a Universal Serial Bus(hereinafter simply referred to as “USB”) port 600, and a mouse part 700.

The USB port 600 and the mouse part 700 are the same elements as the USB port 200 and the mouse part 300 shown in FIG. 2.

The MPEG decoding part 500 further includes an audio video parser 530, an audio signal controller 540, an audio signal decoder 550, an audio signal output part 560, a video signal controller 570, a video signal decoder 580, and a video signal output part 590 as well as a regulator 501, a portable power supply 503, a micro computer 510, and a memory card 520.

The audio video parser 530 receives an audio/video signal outputting from a recording material such as memory card through an external device. The audio/video signal is separated into an audio signal and a video signal by a demultiplexer(not shown) within the audio video parser 530.

The audio signal controller 540 receives the separated audio signal. The audio signal controller 540 also computes the timing for audio reproduction output based on the audio decoder timing or an initial delay time of the audio decoder 550. Additionally, the audio signal controller 540 controls the audio signal decoder 550 by using the inputted time.

The audio signal decoder 550 decodes the audio signal and then converts a digital audio signal into an analog audio signal, so as to output the analog audio signal at the audio signal output part 560.

On the other hand, the video signal controller 570 receives the separated video signal. The video signal controller 570 also computes the timing for video reproduction output based on the video decoder timing or an initial delay time of the video decoder 580. Additionally, the video signal controller 570 controls the video signal decoder 580 by using the inputted time.

The video signal decoder 580 decodes the video signal and then converts a digital video signal into an analog video signal, so as to output the analog video signal at the video signal output part 560.

### Second Embodiment

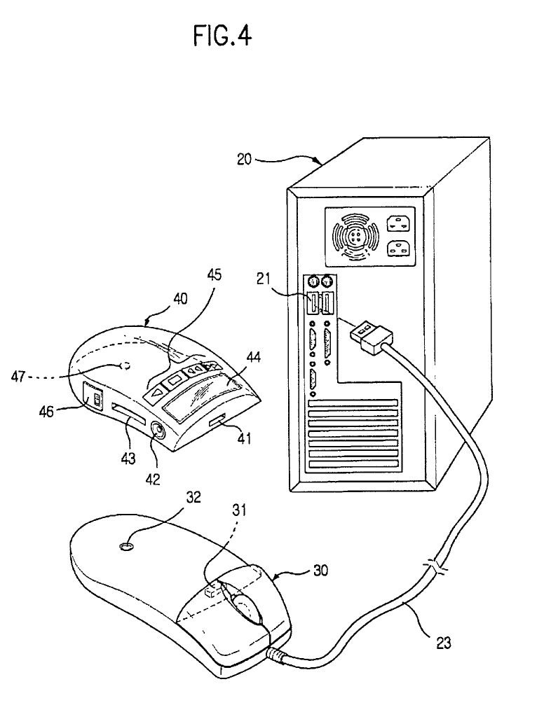

FIG. 4 shows a computer mouse having a structure which can affix or separate an MPEG decoding part according to the second embodiment of this invention.

Referring to FIG. 4, the computer mouse 30 is comprised of a coupling recess 41, an earphone jack 42, a card inserting part 43, a display part 44, an operating part 45, a portable power supply 46, and connecting terminals 32 and 47.

The computer mouse 30 is formed with a space for affixing an MPEG decoding part 40. The coupling recess 41 of the MPEG decoding part 40 can couple with a hook 31 of the body of the computer mouse 30 and separate from the hook 31.

The first connecting terminal 32 and the second connecting terminal 47 are each formed on the surface of the computer mouse 30 and the MPEG decoding part 40, and are electrically and mutually connected. When the MPEG decoding part 40 is affixed on the computer mouse 30 and is used, data are received and transmitted, and also power is supplied through the first and second terminals 32 and 47. After the memory card is inserted into the card inserting part 43 of the MPEG decoding part 40, the MPEG decoding part 40 is affixed and coupled in the space formed in the body of the computer mouse 30.

The MPEG decoding part 40 can separate from the computer mouse 30 to carry the MPEG decoding part 40, thus the MPEG decoding part 40 includes the earphone jack 42, the card inserting part 43, and the portable power supply 46.

Furthermore, the second embodiment can use the circuits of FIGS. 2, 3, and 5 the same as the first embodiment.

FIG. 5 shows a detail circuit of the block diagram of FIG. 2

According to the present invention, an MPEG decoder or MP3 player can be affixed within the same body of a computer mouse or can be easily mounted on the top of the computer mouse. Therefore, a connecting means like a cable does not need to store data in a memory card. And the data can be played without any other MPEG decoder.

While this invention has been particularly shown and described with reference to particular embodiments thereof, it will be understood by those skilled in the art that various changes in form and details may be effected therein without departing from the spirit and scope of the invention as defined by the appended claims.

What is claimed is:

1. A computer mouse having data recording and decoding function, the computer mouse comprising:
a card inserting part for inserting a memory card in a body of the computer mouse;
an output part for reading and outputting data stored in the memory card; and
a Moving picture experts group decoding part to control storing and decoding data by cooperating with the card inserting part having a memory card and the output part.

2. The computer mouse as claimed in claim 1, wherein further comprising:
a cable connector for affixing or separating a cable connecting the computer mouse and a computer; and
an operating part for generating a control signal to output the data.

3. The computer mouse as claimed in claim 1, wherein the output part includes an earphone jack and a display part which are mounted at a surface of the computer mouse.

4. The computer mouse as claimed in claim 1, wherein the computer mouse is connected with a universal serial bus port mounted at the back of the computer.

5. The computer mouse as claimed in claim 1, wherein the moving picture experts group decoding part decodes and outputs an audio signal.

6. A computer mouse having data recording and decoding function, the computer mouse comprising:
a moving picture experts group decoding part including a card inserting part for inserting a memory card, and an output part for outputting data stored in the memory card, and
connecting terminals affixed each with the moving picture experts group decoding part and the computer mouse for electrically and optionally connecting the moving picture experts group decoding part and the computer mouse within a space for setting the Moving picture experts group decoding part on body of the computer mouse.

7. The computer mouse as claimed in claim 6, wherein the output part includes an earphone jack and a display part which are mounted at a surface of the moving picture experts group decoding part.

8. The computer mouse as claimed in claim 6, wherein the moving picture experts group decoding part decodes and outputs an audio signal.

9. The computer mouse as claimed in claim 6, wherein the computer mouse connects with a Universal Serial Bus port mounted at the back of the computer.

10. A computer mouse having data recording and decoding function, the computer mouse comprising:
a mouse part including switching buttons for selecting one of command buttons displayed on a screen of a computer connected to the computer mouse, and
a mouse controller for receiving a click signal by one of the switching buttons and for transmitting the click signal to the computer; and
a moving picture experts group decoding part including a micro-computer for receiving data transmitted from the computer in response to the click signal,
a memory card for storing the data according to control of the micro-computer, and
an audio signal output part for outputting an audio signal in response to the control of the micro-computer.

11. The computer mouse as claimed in claim 10, wherein the moving picture experts group decoding part further comprising;
an audio signal decoder for receiving the audio signal from the memory card and decoding the audio signal; and
a digital to analog converter for converting the digital audio signal decoded into an analog signal.

12. The computer mouse as claimed in claim 10, wherein the moving picture experts group decoder further comprising;
an audio video parser for receiving an audio video signal from the memory card and separating into each audio signal and video signal;
an audio signal decoder for decoding the audio signal outputted from the audio video parser;
an audio signal output part for outputting the audio signal;
a video signal decoder for decoding the video signal outputted from the audio video parser; and
a video signal output part for outputting the video signal.

13. The computer mouse as claimed in claim 10, wherein the moving picture experts group decoder further comprising a display part for displaying predetermined data.
